(19) United States
(12) Patent Application Publication
(10) Pub. No.: US 2019/0367840 A1
(43) Pub. Date: Dec. 5, 2019

(54) DISHWASHING DETERGENT AND METHODS OF MAKING AND USING THE SAME

(71) Applicant: Diversey, Inc., Fort Mill, SC (US)

(72) Inventors: Prashant Kumar Pandey, Mumbai (IN); Anant Kondiram Parte, Mumbai (IN)

(21) Appl. No.: 16/537,950

(22) Filed: Aug. 12, 2019

Related U.S. Application Data
(63) Continuation of application No. 14/673,042, filed on Mar. 30, 2015.
(60) Provisional application No. 62/023,603, filed on Jul. 11, 2014.

(51) Int. Cl. C11D 3/30; C11D 17/00

(52) U.S. Cl. CPC C11D 3/30; C11D 17/0047

(57) ABSTRACT

Provided is a dishwashing detergent composition, which includes a quaternary ammonium salt and a ware cleaning formulation, and method of making and using thereof. In particular, the quaternary ammonium salts may have a structure of

[NR₁R₂R₃R₄]⁺.X⁻
wherein
   each of R₁, R₂, R₃, and R₄ is independently selected from the group consisting of hydrogen, C1-C10 alkyl, H—(OCH₂CH₂)ₘ—, R_{T}COO(CH₂)ₙ—, R_{T}CONH(CH₂)ₙ—, and R_{T};
   at least one of R₁, R₂, R₃, and R₄ is R_{T}COO(CH₂)ₙ—, R_{T}CONH(CH₂)ₙ—, and R_{T};
   n is 1, 2, 3, 4, or 5;
   m is at least 1;
   R_{T} is a C10-C30 saturated or unsaturated hydrocarbon chain; and
   X is a counterion.

### CROSS-REFERENCE TO RELATED APPLICATIONS

This application is a continuation of U.S. patent application Ser. No. 14/673,042 filed Mar. 30, 2015, which application claims the benefit of and priority to U.S. Provisional Patent Application No. 62/023,603 filed Jul. 11, 2014, the entire content of which is hereby incorporated by reference.

### TECHNICAL FIELD

The present invention generally relates to a dishwashing detergent composition, which includes a quaternary ammonium salt as rinse aid.

### BACKGROUND OF THE DISCLOSURE

The use of rinse aids as additives in detergent formulations is to obtain a sheeting effect that gives the dishes a spotless shiny appearance. These aids are wetting agents that are introduced in the final rinse cycle, and they have the function of lowering the surface tension of rinse water so that it forms a closed film on the dish surface. This film becomes thinner during the rinse-off process and finally disappears to ensure that the dry dishes have a uniform shine. The rinse aids allow the water to drain effectively and quickly from the dishes so that the dishes are free from spots and residues.

Traditionally, rinse aids have been composed of nonionic surfactants, hydrotropes, and pH regulators. With the increase in the unit dose forms in the marketplace, more manufacturers have combined the functionality of dishwashing detergent and rinse aid in a single product. Many of these types of products are in tablet form and are primarily available in the consumer market (less available in industrial applications). Typically, the rinse aid in these products is prevented from dissolving during the wash cycle. The requirement is, however, that the solid rinse aid-containing portion survives the wash cycle and is also not pumped off between cycles. This approach sometimes may involve leaving a surface coating on the dishware that reportedly provides multiuse benefits.

International Patent Publication No. WO 2010/065483 and WO 2008/147940 disclose use of cationic starch and polysaccharides, respectively, as rinse agent, which eliminate the need for a surfactant in the rinse step and provide a sheeting effect for machine ware washing. However, when put into tablet or powder formulation, the cationic starches are found to behave differently on different substrates, especially on metal surfaces.

Compared to liquid and other non-liquid forms of detergents, the tablet form provides consumers with additional convenience of use, including ease of dispensing and handling (i.e., no dosing and dispensing aids are needed), precise dosing, smaller packages, and extra portability. More advantageously, the tablet may include Auto-Dishwashing detergent (ADD) formulations that provide sustained disintegration with controlled dissolution and the ability to last for numerous washes, irrespective of operational conditions.

Therefore, there is a need for detergent compositions that provide an improved sheeting effect and drying properties without a separate rinse aid component. In particular, such detergent compositions may be in a tablet form to provide convenience of handling and controlled dissolution.

### SUMMARY OF THE DISCLOSURE

In one aspect, a dishwashing detergent composition is provided. The dishwashing detergent composition includes a quaternary ammonium salt and a ware cleaning formulation. In particular, the quaternary ammonium salts may have a structure of

[NR₁R₂R₃R₄]⁺.X⁻
wherein
each of R₁, R₂, R₃, and R₄ is independently selected from the group consisting of hydrogen, C1-C10 alkyl, H—(OCH₂CH₂)ₘ—, R_{T}COO(CH₂)ₙ—, R_{T}CONH(CH₂)ₙ—, and R_{T};
at least one of R₁, R₂, R₃, and R₄ is R_{T}COO(CH₂)ₙ—, R_{T}CONH(CH₂)ₙ—, and R_{T};
n is 1, 2, 3, 4, or 5;
m is at least 1;
R_{T} is a C10-C30 saturated or unsaturated hydrocarbon chain; and
X is a counterion.

In another aspect, the quaternary ammonium salt includes bis(tallow amidoethyl)polyethoxy-methylammonium methosulfate or N,N-di(2-tallow amidoethyl)-N-(2-hydroxyethyl)-N-methylammonium methylsulfate. The dishwashing detergent composition can be a liquid, a powder, or a tablet. In a particular aspect, the dishwashing detergent composition is a tablet which may provide controlled dissolution under automatic washing conditions.

In yet another aspect, a method for washing wares in an automatic ware washing machine is provided. The method includes contacting the wares with a dishwashing detergent composition, which includes a ware cleaning formulation and a quaternary ammonium salt having the structure of

[NR₁R₂R₃R₄]⁺.X⁻
wherein
each of R₁, R₂, R₃, and R₄ is independently selected from the group consisting of hydrogen, C1-C10 alkyl, H—(OCH₂CH₂)ₘ—, R_{T}COO(CH₂)ₙ—, R_{T}CONH(CH₂)ₙ—, and R_{T};
at least one of R₁, R₂, R₃, and R₄ is R_{T}COO(CH₂)ₙ—, R_{T}CONH(CH₂)ₙ—, and R_{T};
n is 1, 2, 3, 4, or 5;
m is at least 1;
R_{T} is a C10-C30 saturated or unsaturated hydrocarbon chain; and
X is a counterion.

Other aspects of the invention will become apparent by consideration of the detailed description and accompanying drawings.

### BRIEF DESCRIPTION OF THE DRAWINGS

FIG. 1 shows the drying performance of various agents based on the visual appearance of the substrates after the drying test, as described in Example 1. Each substrate was given a score of 0-10. A lower score indicates a less satisfactory result (e.g. marks and depositions on the substrate's surface); and a higher score indicates a cleaner surface with less marks and depositions after the drying test.

FIG. 2 shows the drying times of different substrates in drying tests using Varisoft® LM 222 and cationic starch based rinse aid agents (Vector IC 27216 and Solbond), as described in Example 1.

FIG. 3 shows the drying time of different substrates using representative tablet compositions (P3/1 V8 at 1 g/L; and P3/12 VS5 at 0.7 g/L), compared to the standard, as described in Example 2.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

### DETAILED DESCRIPTION

The use of “including,” “comprising,” or “having” and variations thereof herein is meant to encompass the items listed thereafter and equivalents thereof as well as additional items. Any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc, New York, 2001; Larock, Comprehensive Organic Transformations, VCH Publishers, Inc., New York, 1989; Carruthers, Some Modern Methods of Organic Synthesis; 3^{rd} Edition, Cambridge University Press, Cambridge, 1987; the entire contents of each of which are incorporated herein by reference.

The present disclosure relates to provide a dishwashing detergent composition, which includes a quaternary ammonium salt and a ware cleaning formulation. In one embodiment, the quaternary ammonium salts may have a structure of

[NR₁R₂R₃R₄]⁺.X⁻
wherein
each of R₁, R₂, R₃, and R₄ is independently selected from the group consisting of hydrogen, C1-C10 alkyl, H—(OCH₂CH₂)ₘ—, R_{T}COO(CH₂)ₙ—, R_{T}CONH(CH₂)ₙ, and R_{T};
at least one of R₁, R₂, R₃, and R₄ is R_{T}COO(CH₂)ₙ—, R_{T}CONH(CH₂)ₙ—, and R_{T};
n is 1, 2, 3, 4, or 5;
m is at least 1;
R_{T} is a C10-C30 saturated or unsaturated hydrocarbon chain; and
X is a counterion.

The term “alkyl” as used herein, means a straight or branched, saturated hydrocarbon chain. The term “hydrocarbon chain” means a linear or branched substituent group that contains only carbon and hydrogen. Examples of C1-C10 alkyl include methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, n-decyl.

Suitably, the quaternary ammonium salt includes a H—(OCH₂CH₂)ₘ— group, in which m is at least 1. In some embodiments, the quaternary ammonium salt includes a H—(OCH₂CH₂)ₘ— group wherein m is at least 10, at least 20, at least 50, at least 100, or at least 1000.

At least one of the four substituent groups (i.e. R₁, R₂, R₃, and R₄) of the quaternary ammonium salt is R_{T}COO(CH₂)ₙ—, R_{T}CONH(CH₂)ₙ—, or R_{T}. For example, one or more of R₁, R₂, R₃ and R₄ can be selected from R_{T}COO(CH₂)ₙ—, R_{T}CONH(CH₂)ₙ—, or R_{T}. Preferably, two of R₁, R₂, R₃ and R₄ are independently selected from R_{T}COO(CH₂)ₙ—, R_{T}CONH(CH₂)ₙ—, or R_{T}. R_{T} may contain at least 10, at least 12, at least 14, at least 16, at least 18, at least 20, at least 22, at least 24, at least 26, at least 28, or at least 30 carbons. R_{T} may contain less than 30, less than 28, less than 26, less than 24, less than 22, less than 20, less than 18, less than 16, less than 14, or less than 12 carbons. Typically, r is a hydrocarbon chain that may contain 10 to 30 carbons, such as 10 to 25 carbons, or 10 to 20 carbons, or 12 to 20 carbons. Preferably, R_{T} contains 12-20 carbons. R_{T} may be a saturated hydrocarbon chain, including for example a linear or a branched alkyl chain, or R_{T} may be an unsaturated hydrocarbon chain containing one or more C═C double bonds. R_{T} may contain at least 1, at least 2, at least 3, at least 4, at least 5, or at least 6 C═C double bonds. R_{T} may contain less than 6, less than 5, less than 4, less than 3, or less than 2 C═C double bonds. Preferably, R_{T} may contain 0, 1, 2, or 3 C═C double bonds.

R₁ may be connected to the central nitrogen atom of the quaternary ammonium ion via an ester link (such as R_{T}COO(CH₂)ₙ—N), or an amide link (such as R_{T}CONH(CH₂)ₙ—N), or a bond (such as R_{T}—N). In some embodiments, the acyl group of R_{T}CO— and its ester and amide derivatives include those known in art as tallow acyl, tallow esters, and tallow amides. The term “tallow” refers to a substituent group derived from animal fat (i.e. triglyceride) that contains saturated and unsaturated fatty acids. Accordingly, tallow acyl means saturated and unsaturated fatty acid groups, and tallow ester and tallow amide mean the ester and amide derivatives of tallow acyl. For example, tallow acyl may include the acyl groups from saturated fatty acids, such as palmitic acid (C16), steric acid (C18), and myristic acid (C14); monounsaturated fatty acids, such as oleic acid (C18), and palmitoleic acid (C16); and polyunsaturated fatty acids Saturated fatty acids, such as linoleic acid (C18) and linolenic acid (C18) In general, tallow contains a variety of fatty acids. For example, fatty acids in beef tallow include myristic (3%), palmitic (27%), palmitoleic (3%), stearic (15%), oleic (48%), linoleic (3%), and linolenic acids (1%) (Johnson M. C., Tester J. W. “Lipid Transformation in Hydrothermal Processing of Whole Algal Cells.” Industrial & Engineering Chemistry Research. 2013, 52, 10988-10995). In some embodiments, the quaternary ammonium ion of the present disclosure includes tallow acyl groups, which include a mixture of different fatty acyl groups.

In one embodiment, R₁ and R₂ are each independently R_{T}COO(CH₂)— or R_{T}CONH(CH₂)ₙ—, R₃ is C1-C4 alkyl, R₄ is H—(OCH₂CH₂)ₘ— (m is at least 1). In another embodiment, R₁ and R₂ are both tallow amidoethyl, R₃ is methyl, and R₄ is H—(OCH₂CH₂)ₘ— (m is at least 1).

The counterion of quaternary ammonium salt (X) may include any negatively charged ion that does not interfere with the cleaning effectiveness and consumer safety of the dishwashing detergent. Suitable counterions include halogen and methylsulfate. Preferably, the counterion is methylsulfate. In some embodiments, the quaternary ammonium salt includes bis(tallow amidoethyl)polyethoxy-methylammonium methosulfate (CAS No. 68410-69-5) or N,N-di(2-tallow amidoethyl)-N-(2-hydroxyethyl)-N-methylammonium methylsulfate (CAS No. 68153-35-5). Commercial quaternary ammonium salt products suitable for the present disclosure include those known as fabric softeners, such as Varisoft® 222 LM (Evonik), which contains N,N-di(2-tallow amidoethyl)-N-(2-hydroxyethyl)-N-methylammonium methylsulfate (CAS No. 68153-35-5) at a concentration of approximately 80-90%. The quaternary ammonium salt in Varisoft® 222 LM also may be known in the art under various synonymous chemical names covered by CAS No 68410-69-5.

The dishwashing detergent composition may comprise at least about 0.5%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13^{%}, at least about 14%, at least about 15%, at least about 16%, at least about 17%, at least about 18%, or at least about 19% by weight of the quaternary ammonium salt. The dishwashing detergent composition may comprise less than about 20%, less than about 19%, less than about 18%, less than about 17%, less than about 16%, less than about 15%, less than about 14%, less than about 13%, less than about 12%, less than about 11%, less than about 10%, less than about 9/%, less than about 8%, less than about 7%, less than about 6%, less than about 5¹%, less than about 4%, less than about 3° %, less than about 2%, or less than about 1% by weight of the quaternary ammonium salt. The quaternary ammonium salt may be present in an amount of about 0.5% to about 20% by weight of the dishwashing detergent composition. For example, the quaternary ammonium salt may be present in about 0.5% to about 15%, about 0.5% to about 10%, or about 1% to about 10% by weight of the composition. Preferably, the quaternary ammonium salt is present in an amount of about 1% to about 10% by weight of the composition.

The ware cleaning formulation includes at least one ingredient selected from the group consisting of alkalinity source, bleaches, surfactant, sequestrating agent, defoamer, and enzymes. Examples of suitable ingredients include those described in U.S. Pat. No. 8,343,286, which in incorporated by reference herein in its entirety. The detergent composition can be in a form of a liquid, powder, or tablet.

Suitable alkalinity sources include, but are not limited to, sodium carbonate (soda ash), caustic agents (such as sodium or potassium hydroxides), and alkali metal silicates (such as sodium metasilicate). Especially effective is sodium silicate having a mole ratio of SiO₂:Na₂O of from about 1.0 to about 3.3. The pH of the detergent composition typically is in the alkaline region, preferably having a pH of ≥9, and more preferably ≥10.

Surfactants may enhance cleaning and/or to act as defoamers. Suitable surfactants include cationic surfactant, anionic surfactants, amphoteric surfactants, zwitterionic surfactants, nonionic surfactants, and mixtures thereof. Examples of suitable surfactants include those disclosed in U.S. Pat. Nos. 7,375,068 and 7,943,565, each of which is incorporated by reference herein in its entirety. The surfactant may be present in a concentration of at least about 1%, at least about 2%, at least about 3%, at least about 4%, at least about 5%, at least about 6%, at least about 7%, at least about 8%, or at least about 9% by weight. The surfactant may be present in a concentration of less than about 10% less than about 9%, less than about 8%, less than about 7%, less than about 6%, less than about 5%, less than about 4%, less than about 3%, less than about 2%, or less than about 1% weight. Typically, surfactant may be present in a concentration of about 0% to about 10% by weight, preferably from 05% to about 5% by weight, most preferably from about 0.2% to about 2% by weight.

Suitable bleaches include halogen-based bleaches or oxygen-based bleaches. More than one kind of bleach may be used. As halogen bleach, alkali metal hypochlorite may be used. Other suitable halogen bleaches are alkali metal salts of di- and tri-chloro and di- and tri-bromo cyanuric acids. Suitable oxygen-based bleaches are the peroxygen bleaches, such as sodium perborate (tetra- or monohydrate), sodium carbonate or hydrogen peroxide. The halogen-based bleaches (such as hypochlorite, di-chloro cyanuric acid) may be present in an amount of at least about 1%, at least about 3%, at least about 5%, at least about 7%, at least about 9%, at least about 11%, or at least about 13% by weight. The halogen-based bleaches may be present in an amount of no more than about 15%, no more than about 13%, no more than about 11%, no more than about 9%, no more than about 7%, no more than about 5%, no more than about 3%, or no more than about 1% by weight. Typically, the halogen-based bleaches may be present in an amount of about 1% to about 15%, preferably about 1% to about 10% by weight.

The oxygen-based bleaches (such as sodium perborate or sodium carbonate) may be present in an amount of at least about 1%, at least about 5%, at least about 10%, at least about 15%, or at least about 20% by weight. The oxygen-based bleaches may be present in an amount of no more than about 25%, no more than about 20%, no more than about 15%, no more than about 10%, no more than about 5%, or no more than about 1% by weight. Typically, the halogen-based bleaches may be present in an amount of about 1% to about 25%%, preferably about 4% to about 25% by weight.

For solid detergents in the form of a powder, granulated powder, tablet, briquette or solid block the use of a solid defoaming agent, or defoamer, might be preferred. Suitable defoamers include polyethylene glycol and polypropylene glycol copolymers (known as EO/BO type defoamers) and silicone based defoamer (such as organically modified siloxanes, and silicone liquids, emulsions and powders). Examples of suitable solid defoamers include SILFOAM® SP 150 (Wacker Chemie AG; Silicone Antifoam Powder) or DC 2-4248S (Dow Corning; powdered antifoam).

The sequestrating agent inhibits scale formation resulting from the crystallization of calcium and magnesium salts (such as carbonate) from liquid within the dishwasher and the precipitation of the solid crystals on the surfaces of the washed items and the washing machine. The sequestrating agent can include a phosphate-based or non-phosphate formulation. Phosphate-based sequestrating agents typically include alkali metal salts of polyphosphates (such as sodium tripolyphosphate) and phosphonic acid. Non-phosphate sequestrating agents typically include a low molecular weight acrylic acid polymer (e.g. average molecular weight <20,000); aminocarboxylic acids, such as nitrilotriacetic acid (NTA), methylglycine diacetic acid (MGDA), glutamic acid diacetic acid (GLDA), diethylene triamine pentaacetic acid (DTPA), hydroxyethyl ethylene diamine triacetic acid (HEDTA), ethylenediaminetetraacetic acid (EDTA) and combinations thereof; and phosphonic acid, such as i-hydroxyethane 1,1-diphosphonic acid (HEDP), amino tris(methylenephosphonic acid) (ATMP), ethylenediamine tetra(methylene phosphonic acid) (EDTMP), tetramethylenediamine tetra(methylene phosphonic acid) (TDTMP), hexamethylenediamine tetra(methylene phosphonic acid) (HDTMP), diethylenetriamine penta(methylene phosphonic acid) (DTPMP), and combinations thereof.

Suitably, the detergent composition contains a non-phosphate formulation, and the total phosphorus content in the composition is controlled at a low level. For example, the element phosphorus content can be in the detergent composition can be no more than 4%, no more than 3%, no more than 2%, no more than 1%, or even no more than 0.5% by weight of the composition. Preferably, the element phosphorus content is no more than 1% by weight of the scale inhibition composition. Suitably, the sequestrating agent contains low level of NTA, or is free of NTA. Preferably, the detergent composition includes a sequestrating blend which includes low molecular weight acrylic acid polymer, an aminocarboxylic acid other than NTA, and a phosphonic acid. In one embodiment, the sequestrating agent contains low molecular weight acrylic acid polymer (average molecular weight <12,000), MGDA, and HEDP, as described in U.S. Ser. No. 14/329,642 to Parte et al. (“SCALE-INHIBITION COMPOSITIONS AND METHODS OF MAKING AND USING THE SAME,” filed Jul. 11, 2014, Atty. Ref. 083258-8046), which is incorporated by reference herein in its entirety.

Various defoamers can be used in the detergent composition as known to those skilled in the art. In some embodiments, EO/BO types of defoamers, organically modified siloxanes, silicone liquids, emulsion and powders can be used. In some embodiments, a solid defoaming agent may be preferred. Examples of suitable solid defoamers are: SILFOAM® SP 150 (Wacker Chemie AG; Silicone Antifoam Powder) or DC 2-4248S (Dow Corning; powdered antifoam).

In some embodiments, the dishwashing detergent composition can be in the form of a liquid, a powder, or a tablet. Suitably, the dishwashing detergent composition is a tablet, which may further include as a binder. In particular, the binder can be a crosslinked acrylic acid polymer having a weight average molecular weight (Mw) of at least 500,000, as described in U.S. Ser. No. 62/023,602 to Parte et al. (“TABLE. DISHWASHING DETERGENT AND METHODS FOR MAKING AND USING THE SAME,” filed Jul. 11, 2014, Atty. Ref. 083258-8058), which is incorporated by reference herein in its entirety. Polymers suitable for the present disclosure include carbomer copolymers, which are high molecular weight copolymers of acrylic acid and a long chain alkyl methacrylate crosslinked with allyl ethers of polyalcohol. Commercial carbomer products useful for the present disclosure include, for example, Carbopol® Ultrez 20 and Carbopol® 674 by Lubrizol Corporation.

The dishwashing detergent composition of the present disclosure demonstrates improved drying performance comparable to or better than the conventional, separate rinse aid system. The dishwashing detergent composition provide a layer of quaternary ammonium salt on the wares so as to afford a sheeting action in an aqueous rinse step without any added rinse agent Without limiting the scope of present disclosure, it is hypothesized that, because of their cationic nature, the cationic quaternary ammonium salt described herein (e.g. bis(tallow amidoethyl)polyethoxy-methylammonium methosulfate or N,N-di(2-tallow amidoethyl)-N-(2-hydroxyethyl)-N-methylammonium methylsulfate) adheres to the negatively charged surface of substrate, such that the surface becomes more hydrophilic in a variety of substrates, including glass, plastic, and stainless steel. Such hydrophilic surface allows water to get rinsed off from surface, thus providing improved sheeting effect.

In another aspect, the present disclosure also provides a method for washing wares in an automatic ware washing machine, the method comprising contacting the wares with a dishwashing detergent composition comprising a ware cleaning formulation and a quaternary ammonium salt having the structure of

[NR₁R₂R₃R₄]⁺.X⁻
wherein
each of R₁, R₂, R₃, and R₄ is independently selected from the group consisting of hydrogen, C1-C10 alkyl, H—(OCH₂CH₂)ₘ—, R_{T}COO(CH₂)ₙ—, R_{T}CONH(CH₂)ₙ—, and R_{T};
at least one of R₁, R₂, R₃, and R₄ is R_{T}COO(CH₂)ₙ—, R_{T}CONH(CH₂)ₙ—, and R_{T};
n is 1, 2, 3, 4, or 5;
m is at least 1;
R_{T} is a C10-C30 saturated or unsaturated hydrocarbon chain; and
X is a counterion.

In some embodiments, the ware cleaning formulation comprises at least one ingredient selected from the group consisting of alkalinity sources, surfactants, sequestrating agent, defoamer, and combinations thereof. In one embodiments, the quaternary ammonium salt comprises bis(tallow amidoethyl)polyethoxy-methylammonium methosulfate or N,N-Di(2-tallow amidoethyl)-N-(2-hydroxyethyl)-N-methyl ammonium methylsulfate. The dishwashing detergent composition is a liquid a powder, or a tablet. In one embodiment, the dishwashing detergent composition is a tablet.

In another aspect, the present disclosure also provides a method of washing wares, which includes contacting a wash liquid with the dishwashing detergent composition of the present disclosure (such as a detergent tablet) in an automatic dishwashing machine. Examples of wares include, but are not limited to, dishware, pots, pans, silverware, cooking utensils, eating utensils, cutlery, tumblers, and crockery. In various embodiments, automatic dishwashing machines, which may include hood type dishwashing machines or under-counter glass washers, generally include machines for both household and industrial applications. Advantageously, the method disclosed herein is particularly suitable for industrial application. Typically, the presently disclosed detergent composition can be used at a water hardness of less than about 400 ppm, such as less than about 350 ppm, less than about 300 ppm, less than about 250 ppm, less than about 200 ppm, less than about 150 ppm, less than about 100 ppm, or less than about 50 ppm. For effective drying, a water hardness of less than 200 ppm, preferably less than about 150 ppm may be employed. Rinse water temperature can be equal to or lower than about 90° C. Wash tank temperature can be equal to or lower than about 65° C. Rinse water flow rate or pressure can be equal to or lower than about 300 l/h. Wash time can range from about 30 seconds to about 2 minutes. Rinse time can range from about 5 seconds to about 30 seconds. Advantageously, using the presently disclosed detergent composition (e.g. a tablet) in washing machines causes only a low level of foaming under these operating conditions. In some embodiments, only a minimal level of foaming, or even essentially no foaming, can be observed. For example, a foam height of less than about 10 cm, less than about 5 cm, or even less than about 2 cm may be achieved. In some embodiments, the minimal foaming or no foaming results can be achieved even under heavy soiling conditions.

Suitable automatic ware washing machines include, but are not limited to, institutional ware washing machines. The present method is suitable for household and industry ware washing. The present method suitable for the cleaning of a variety of wares, such as glass, plastic, and stainless steel. Advantageously, the dishwashing detergent composition containing the quaternary ammonium salt described herein improves the drying performance of a variety of substrates (such as glass, plastic, and stainless steel) without using any additional rinse aids. Thus, no particular restrictions need to be placed on the use of additional raise aid agents in order for a user to obtain satisfactory performance. The improved drying performance of the presently disclosed detergent composition in the absence of other rinse agents, combined with the minimal level of foaming during its use, makes the detergent composition particularly suitable for industrial application, which needs to be user friendly and requires minimum restriction on the user's operation conditions.

In some embodiments, the surface of the ware after washing dries in less than 10 minutes, less than about 9 minutes, less than about 8 minutes, less than about 7 minutes, less than about 5 minutes, less than about 4 minutes, less than about 3 minutes, less than about 2 minutes, or even less than about 1 minute. Preferably, the surface of the ware dries in less than about 3 minutes. More preferably, the surface of the ware dries in less than about 1 minute.

The following non-limiting examples illustrate the detergent tablet of the present invention and method of use thereof.

### EXAMPLES

### Example 1. Drying Performance of Various Agents

The drying performance various agents, including quaternary ammonium salts, were examined in a drying test on three different types of substrates using an institutional single tank dishwashing machine.

A base formula in powder form was prepared as shown below. Various liquid formulation were also prepared (not shown) with water soluble defoamers which are stable under alkaline conditions.

| Chemical (Trade Name) | Weight % |
|---|---|
| MGDA Powder (Trilon M) 84% | 5.210% |
| HEDP Powder (CODEX DS) 80% | 1.500% |
| Acrylate polymer (Accusol 445 G) 95% | 5.000% |
| Copolymer (Sokalan PA30 granules) 92% | 2.080% |
| Sodium Meta Silicate Anhydrous 100% | 10.000% |
| Antifoam (SilFoam) 100% | 1.000% |
| Soda Ash 100% | 60.00% |
| Soda Ash | Balance |

Next, a series of test formulations were made by adding to the base formula one of the following quaternary ammonium salts at a pre-determined concentration: Vector IC 27216 from Roquette, a cationic starch (8%); Mirapol Surf S from Solvay (4%); Accosoft 808 from Stepan (tallow imidazoline, 1%); Accosoft 808 (tallow imidazoline, 4%); Accosoft 501 from Stepan (tallow diamidoamine, 4%); Arquad HT 75 from Sigma-Aldrich (hydrogenated tallow esterquat, 4%); Stepantax VK 90 from Stepan (ditallowate esterquate, 4%); Varisoft LM 222 from Evonik (tallow amidoethyl, 4%); and Solbond NE 60 from Solam (cationic starch, 4%). A standard liquid detergent and a standard liquid rinse aid (collectively referred to as “the standard”) was used together as a reference to indicate benchmark results currently achieved by industrial dishwashing machines. Generally, the standard liquid detergent was an aqueous solution containing 20% sodium hydroxide, 10% nitrilotriacetic acid sodium salt, 1% aminotrimethylene phosphonic acid, and was dosed at 1 mL/L. The standard liquid rinse aid was an aqueous solution of 0.23% citric acid, 0.8% cumene sulphonic acid sodium salt, 5% EO/PO copolymer (average Mw 2700), 15% EO/PO copolymer (average Mw 2000), 9.5% alcohol (C13-15) alkoxylate (EO/BO), 0.003% blue dye, and 0.00045% methyl/chloromethyl isothiazolinone; and was dosed at 0.5 mL/L.

The drying test was carried out in a single-tank dishwasher (Meiko DV 80.2 hood type). The dishwasher was operated under the following conditions: a tank volume of 22 L; a rinse volume of 3 L; a wash time of 45 seconds; a rinse time of 8 seconds; a drop time of 7 seconds; a wash temperature of 60° C.; a rinse temperature of 80° C.; and a water hardness of 400 ppm. Substrates tested included stainless steel cups (La Chef, Elektroblok B, with a usable area (bottom) of 45×86 mm, glass plates (148×79×4 mm), and plastic plates naturel (Nytralon 6E, Quadrant Engineering Plastic Products, 97×97×3 mm).

The machine was filled with water or water with a formulation to be tested. Two substrates of each kind (only one black dish when used) were placed on a tile with a brace. As a reference test, the tiles were placed in the tray and washed for a first time without adding any of the test formulations. As soon as the wash and rinse cycles were finished, drying time was determined on all substrates. The tray with substrates was temporarily taken out of the machine. The rinse flow line was primed first with water; then a test formulation was dosed in the rinse flow. A few washes are needed to balance concentrations in the wash bath and boiler (10 washes if doses before the boiler, and 4 washes if dosed after the boiler). The tray with substrates was replaced in the machine and washed again, this time with the test formulation dosed in the rinse flow and drying times were evaluated. These measurements were repeated in a total 3 or 5 times when emphasis was on visual appearance (like in tap water and HTDS-water). No extra main wash detergent was added. Drying time was determined (in seconds) of the washed substrates at ambient temperature immediately after opening the machine. When drying time was longer than 300 seconds, it was reported as 300 seconds, and the remaining droplets on the substrates were also counted. The average values of the drying times and the average values of the number of droplets on the substrates after 300 seconds from 3 separate tests (using 2 items for each of glass, plastic, and stainless steel substrates) are shown in Table 1. For each test, a washing process using water without any added rinse aid was carried out as a reference under the conditions.

TABLE 1

| | Glass | | Plastic | | Stainless Steel | |
|---|---|---|---|---|---|---|
| Formulation | Time (sec) | Droplet # | Time (sec) | Droplet # | Time (sec) | Droplet # |
| Standard | 44.0 | 0.0 | 60.0 | 0.0 | 300.0 | 2.3 |
| P3/1 V8 - | 37.3 | 0.0 | 97.5 | 0.0 | 73.3 | 0.0 |
| Vector 8% | | | | | | |
| Mirapol Surf | 60.0 | 0.0 | 300.0 | 11.5 | 300.0 | 21.7 |
| S-4% | | | | | | |
| Accosoft 808 | 54.7 | 0.0 | 300.0 | 6.5 | 230.0 | 1.5 |
| (Tallow | | | | | | |
| Imidazoline) | | | | | | |
| 1.0% | | | | | | |
| Accosoft 808 | 81.2 | 0.0 | 300.0 | 7.0 | 90.5 | 0.0 |
| (Tallow | | | | | | |
| Imidazoline) | | | | | | |
| 4% | | | | | | |
| Accosoft | 66.3 | 0.0 | 300.0 | 17.2 | 96.0 | 4.5 |
| 501 (Tallow | | | | | | |
| Diamidoamine) | | | | | | |
| 4% | | | | | | |
| Arquad HT 75 | 67.5 | 0.0 | 300.0 | 29.8 | 43.8 | 0.0 |
| (Hydrogenated | | | | | | |
| Tallow Ester | | | | | | |
| quat) 4% | | | | | | |
| Stepantax VK | 68.7 | 0.0 | 300.0 | 16.0 | 126.0 | 0.0 |
| 90 (Ditallowate | | | | | | |
| Ester quat) 4% | | | | | | |
| Varisoft LM | 31.8 | 0.0 | 39.0 | 0.0 | 36.5 | 0.0 |
| 222 (tallow | | | | | | |
| amidoethyl) | | | | | | |
| 4% | | | | | | |
| Solbond | 42.1 | 0.0 | 144.8 | 0.0 | 231.8 | 4.0 |
| (Cationic | | | | | | |
| Starch) 4% | | | | | | |

After the drying tests, the visual appearance of the substrates was evaluated. Based on the drying time and number of remaining droplets after 300 seconds, and the appearance of the substrates, a score on a scale of 0-10 (“drying score”) was given to each substrate to characterize the drying performance of the rinse aid agent. A score of 0 means the least satisfactory result, including high level of visual marks like dried water droplets, depositions and scale. A score of 10 means the surface of the substrate is clean, without apparent marks or depositions. The visual examination was carried out by the same person throughout the drying test.

Between different tests, the machine was properly cleaned by emptying and filling the machine. When the test formulation was dosed after the boiler, one wash and rinse cycle was done. When dosing was before the boiler, 50 wash and rinse cycles were done to remove remaining test formulation from the boiler; finally the machine was emptied again. New substrates were used for every new test (in order not to influence the drying results by components possibly adsorbed onto the substrate.

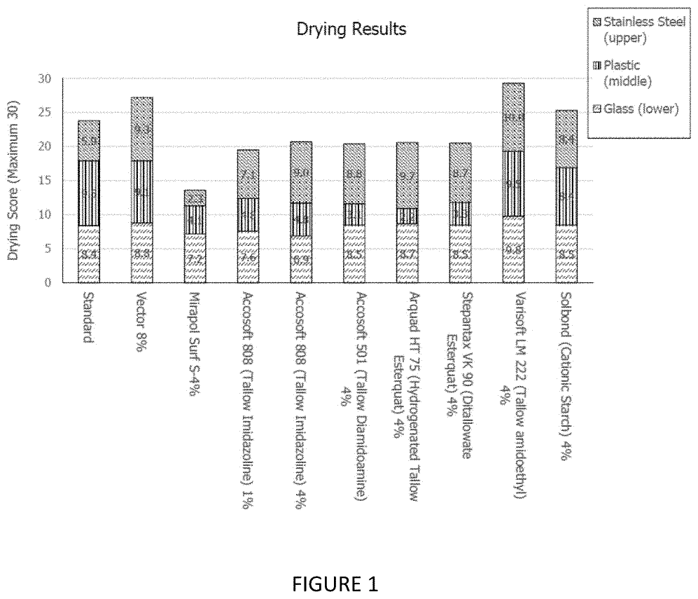

FIG. 1 shows the drying performance of various agents, including quaternary ammonium salts, based on the visual appearance of the substrates after the drying test. After the drying test, each substrate was given a score of 0-10. A lower score indicates more marks and depositions on the substrate's surface; and a higher score indicates a cleaner surface with less marks and depositions after the drying test. As shown in FIG. 1, Varisoft® LM 222 (Evonik) gave highest score in all types of tested substrates compared to other tested rinse aid agents. Also, as shown in Table 1, Varisoft® LM 222 provided shortest drying time and left no droplet after 300 seconds for all tested substrates (glass, plastic, and stainless steel), compared all other tested rinse aid agents. In particular, Varisoft® LM 222 provided better drying performance with both stainless steel and plastic substrates.

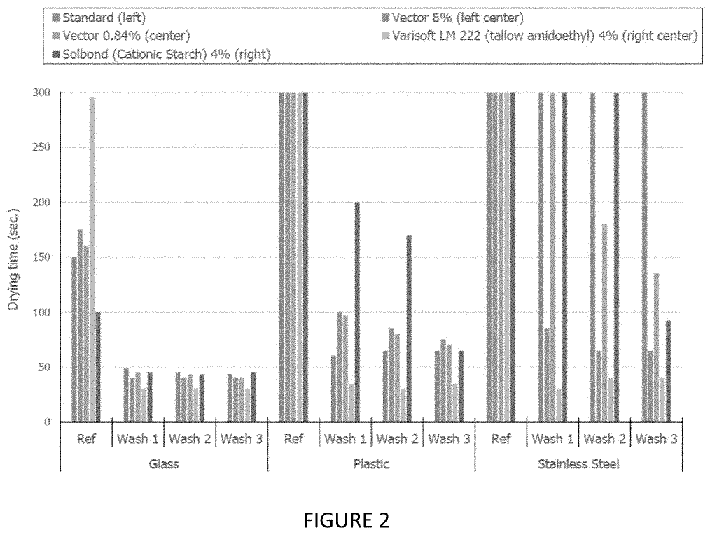

FIG. 2 shows the drying times of different substrates in tests using Varisoft® LM 222 compared to those using cationic starch based rinse aid agents (Vector IC 27216 and Solbond). As shown in FIG. 2, Varisoft® LM 222 reduced drying time from that of the reference (i.e. formulation with no rinse aid agent) in all types of substrates. Also, the drying times of all the substrates tested with Varisoft® LM 222 were shorter than those tested with Vector IC 27216 or Solbond, especially for plastic and stainless steel substrates.

In general, the formulations containing Varisoft® LM 222 showed only a low level of foaming during the above tests in washing machines. Typically, only a minimal level of foaming, or even essentially no foaming, was observed. Advantageously, the formulations containing Varisoft® LM 222 allowed for convenient and effective foam control.

Thus, Varisoft® LM 222 was demonstrated to improve the drying performance of all types of substrates tested (glass, plastic, and stainless steel) by shortening the drying time and by providing a sheeting effect that improved the appearance of substrate's surface after washing. Further, such improvement of drying performance was achieved by including Varisoft® LM 222 in a detergent composition without additional rinse aid agents. Advantageously, Varisoft® LM 222 provided more satisfactory results than the cationic starch agents in terms of both reduction in drying time and visual appearance of the substrates after washing.

### Example 2. Dishwashing Detergent Tablets

The following dishwashing detergent compositions in tablet form were prepared as described in U.S. Ser. No. 62/023,602, which is incorporated by reference herein in its entirety.

| | P3/1- | P3/1- | P3/1- | P3/1- | P3/11- | P3/12- |
|---|---|---|---|---|---|---|
| Chemical (Trade Name) | VS5/UP | VS5/CP | V8/UP | V8/CP | VS5/CP | VS5/CP |
| MGDA (Trilon M) | 5.210% | 5.210% | 5.210% | 5.210% | 5.210% | 7.800% |
| Powder, 84% | | | | | | |
| HEDP (CODEX DS) | 1.500% | 1.500% | 1.500% | 1.500% | 1.500% | 1.500% |
| Powder, 80% | | | | | | |
| Acrylate polymer | 5.000% | 5.000% | 5.000% | 5.000% | 5.000% | 7.500% |
| (Accusol 445 G), 95% | | | | | | |
| Copolymer (Sokalan | 2.080% | 2.080% | 2.080% | 2.080% | 2.080% | 3.120% |
| PA30 granules), 92% | | | | | | |
| Sodium Meta Silicate | 10.000% | 10.000% | 10.000% | 10.000% | 0 | 0 |
| Anhydrous, 100% | | | | | | |
| Sodium Meta Silicate | 0 | 0 | 0 | 0 | 10.000% | 10.000% |
| Pentahydrate, 100% | | | | | | |
| Antifoam (SilFoam), | 1.500% | 1.500% | 1.500% | 1.500% | 1.500% | 1.500% |
| 100% | | | | | | |
| Vector IC, 28% | 0 | 0 | 8.000% | 8.000% | 0 | 0 |
| Varisoft 222 LM, 90% | 5.000% | 5.000% | 0 | 0 | 5.000% | 7.500% |
| Soda Ash, 100% | 60.000% | 60.000% | 60.000% | 60.000% | 60.000% | 59.080% |
| Carbopol 674, 100% | 0 | 2.000% | 0 | 2.000% | 2.000% | 2.000% |
| Ultrez 20, 100% | 2.000% | 0 | 2.000% | 0 | 0 | 0 |
| Balance (Soda Ash) | 7.710% | 7.710% | 4.710% | 4.710% | 7.710% | 0 |

The drying performance of each of these tablet detergent compositions were tested under similar conditions described in Example 1.

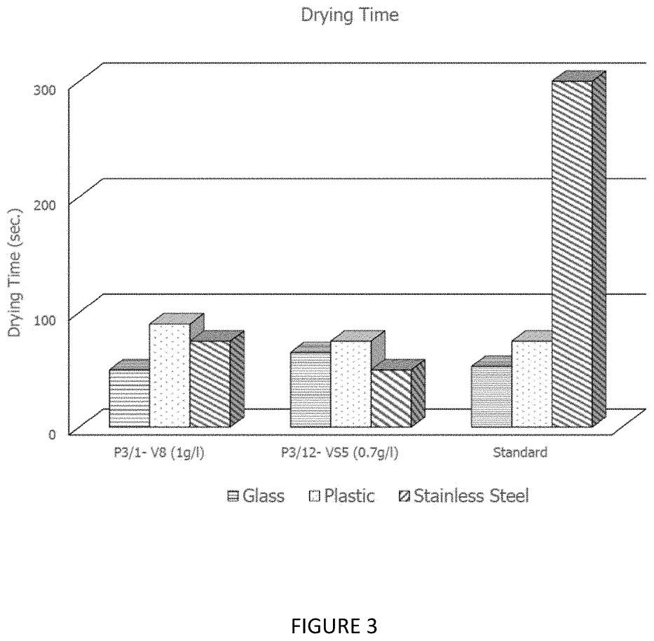

FIG. 3 shows the drying time of different substrates using representative tablet compositions (P3/1 V8 at 1 g/L; and P3/12 VS5 at 0.7 g/L), compared to the standard. As shown in FIG. 3, the drying times of all the substrates (glass, plastic, stainless steel) were below about 80 seconds when was included in the tablet composition (P3/12 VS5). Compared to cationic starch based rinse aid agent (P3/1 V8), Varisoft® LM 222 provides similar drying time in glass substrates and shorter drying time in plastic and stainless steel substrates. In contrast, the drying time for the standard is longer than that of P3/12 VS5 and P3/1 V8 in stainless steel substrates. Therefore, Varisoft® LM 222 as rinse aid agent showed improved drying performance for all types of tested substrate, and provided better drying performance in plastic and stainless steel substrates compared to the tested cationic starch based rinse aid agent.

Thus, it was demonstrated that quaternary ammonium salts described herein, such as Varisoft® LM 222, can be included in a dishwashing detergent tablet to improve the drying performance of all types of substrates. Further, such improvement of drying performance was achieved by including the quaternary ammonium salts in a detergent composition without additional rinse aid agents. Advantageously, in a detergent tablet, Varisoft® LM 222 provided comparable or even shorter drying time than the cationic starch based agents.

Various features and advantages of the invention are set forth in the following claims.

1.-14. (canceled)

15. A method for washing ware, the method comprising:
contacting the ware in a washing step with a dishwashing detergent composition; and
contacting the washed ware in a rinse step with an aqueous rinse, wherein the aqueous rinse is without any added rinse aid agent,
wherein the dishwashing detergent composition comprises a ware cleaning formulation and a quaternary ammonium salt having the structure of
[NR₁R₂R₃R₄]⁺.X⁻
wherein
each of R₁, R₂, R₃, and R₄ is independently selected from the group consisting of hydrogen, C1-C10 alkyl, H—(OCH₂CH₂)ₘ—, R_{T}COO(CH₂)ₙ—, R_{T}CONH(CH₂)ₙ—, and R_{T};
at least one of R₁, R₂, R₃, and R₄ is R_{T}COO(CH₂)ₙ—, R_{T}CONH(CH₂)ₙ—, and R_{T};
n is 1, 2, 3, 4, or 5;
m is at least 1;
R_{T} is a C10-C30 saturated or unsaturated hydrocarbon chain; and
X is a counterion.

16. The method of claim 15, wherein R_{T} is a C12-C20 saturated or unsaturated hydrocarbon chain.

17. The method of claim 15, wherein at least one of R₁, R₂, R₃, and R₄ is R_{T}COO(CH₂)ₙ—.

18. The method of claim 15, wherein at least one of R₁, R₂, R₃, and R₄ is R_{T}CONH(CH₂)ₙ—.

19. The method of claim 15, wherein at least one of R R₁, R₂, R₃, and R₄ is R_{T}.

20. (canceled)

21. The method of claim 15, wherein X is chloride or methylsulfate.

22. The method of claim 15, wherein the ware cleaning formulation comprises at least one ingredient selected from the group consisting of alkalinity sources, surfactants, sequestrating agent, defoamer, or combinations thereof.

23. (canceled)

24. The method of claim 15, wherein the dishwashing detergent composition is a liquid, a powder, or a tablet.

25. The method of claim 15, wherein the dishwashing detergent composition is a tablet.

26. The method of claim 15, wherein the step of contacting the ware in a washing step with a dishwashing detergent composition takes place in an automatic ware washing machine.

27. The method of claim 15, wherein the ware is glass, plastic, or stainless steel.

28. The method of claim 15, wherein the surface of the ware after washing dries in less than 10 minutes.

29. The method of claim 15, wherein the surface of the ware after washing dries in less than 3 minutes.

30. The method of claim 15, wherein the surface of the ware after washing dries in less than 1 minute.

31. The method of claim 15, wherein the quaternary ammonium salt comprises bis(tallow amidoethyl)polyethoxy-methylammonium methosulfate or N,N-di(2-tallow amidoethyl)-N-(2-hydroxyethyl)-N-methylammonium methylsulfate.

32. The method of claim 15, wherein the step of contacting the ware in a washing step with a dishwashing detergent composition takes place in an automatic institutional ware washing machine.

33. The method of claim 15, wherein the quaternary ammonium salt is present in an amount of from about 0.5% to about 20% by weight based on total weight of the dishwashing detergent composition.

34. The method of claim 15, wherein the quaternary ammonium salt is present at an amount from about 1% to about 10% by weight based on total weight of the dishwashing detergent composition.

35. The method of claim 15, wherein R₁ and R₂ each is independently R_{T}COO(CH₂)ₙ— or R_{T}CONH(CH₂)ₙ—; R₃ is C1-C4 alkyl; and R₄ is H—(OCH₂CH₂)ₘ—.

36. The method of claim 15, wherein R₁ and R₂ are both tallow amidoethyl; R₃ is C1-C4 alkyl; and R₄ is H—(OCH₂CH₂)ₘ—.
